(19) United States
(12) Patent Application Publication
(10) Pub. No.: US 2018/0165904 A1
(43) Pub. Date: Jun. 14, 2018

(54) LINE QUEUE MONITORING

(71) Applicant: Spot You More, Inc., Raleigh, NC (US)

(72) Inventors: Joel R. Setchell, Advance, NC (US); James D. Haley, Winston-Salem, NC (US)

(73) Assignee: Spot You More, Inc.

(21) Appl. No.: 15/832,766

(22) Filed: Dec. 5, 2017

Related U.S. Application Data
(60) Provisional application No. 62/431,803, filed on Dec. 8, 2016.

(51) Int. Cl. G07C 11/00; G06T 7/60; H04N 5/247; G06Q 20/20; G08B 21/22

(52) U.S. Cl. CPC G07C 11/00; G06T 7/60; H04N 5/247; G07C 2011/04; G08B 21/22; G06T 2207/30242; G06Q 20/202

(57) ABSTRACT

A system for monitoring a queue in a store. The system may include a server, a database and at least one sensor. The database may be in communication with the server and may store queue parameters. The system includes at least one sensor configured to transmit measured queue characteristics to the server and the server is configured to transmit a message based on a comparison of the measured queue characteristics and the queue parameters stored in the database.

### CROSS-REFERENCE TO RELATED APPLICATIONS

This application claims the benefit of U.S. Provisional Application No. 62/431,803, filed on Dec. 8, 2016, entitled “LINE QUEUE MONITORING,” the entire contents of which are incorporated herein by reference.

### BACKGROUND

### 1. Field of the Invention

The present invention generally relates to line queue monitoring.

### 2. Description of Related Art

Convenience stores, especially stores attached to gas stations, are trying to increase revenue and store traffic. Often convenience stores, especially those attached to a gas station, are often used for eating and restroom breaks by travelers. Having long lines for cash registers and restrooms are a significant deterrent for consumers.

### SUMMARY

The present disclosure describes a system for line queue monitoring, for example at a convenience store. A line queue sensor may be placed in a store (e.g. above product shelf behind POS systems) to monitor line queue consumer volume. Based on defined rules written within an analytics platform (either in store or cloud based) that houses the data pushed up from the sensor device(s), notification alerts may be triggered based on certain events and/or certain data is distributed to relevant stakeholders based on defined frequencies or thresholds.

Further objects, features and advantages of this invention will become readily apparent to persons skilled in the art after a review of the following description, with reference to the drawings and claims that are appended to and form a part of this specification.

### BRIEF DESCRIPTION OF THE DRAWINGS

FIG. 1 is a block diagram of a system for line queue monitoring.

### DETAILED DESCRIPTION

Sensors may be used in conjunction with retail locations such as convenience stores and gas stations. The sensors may be at fixed locations within the stores or may be attached to or integrated within certain devices movable within the store. The sensors fixed within the stores may also interact with the devices to provide location of the devices within the store. The sensors may be associated with one or more queues within the store. For example, the sensor may be a camera in communication with a vision processor that monitors one or more lines in front of an interest point within the store. The sensor may monitor the front counter where consumers pay for gas or products. The sensor a queue in front of a restroom door. The sensor may also be used to track traffic in front of a product display or dispensing station. The product display or dispensing station may include a coffee station, a fountain drink station, a frozen drink station, a food station, a refrigerator station, or other station.

Further, information may be provided that relate the queue characteristics (e.g. number of people in line, length of line, dwell time in line) to one other lines, traffic though the door, and purchases of items within the store. The analysis may compare line queue characteristics to desired queue characteristics or queue characteristics in other stores. Analysis of the line queue characteristics may be based on defined logic and thresholds defined within the sensor, a local server, or a cloud based analytics platform. The local server or analytics platform may house the data pushed up from the sensors, notification alerts may be triggered based on certain events. Certain data may be distributed by the server to relevant stakeholders based on a defined frequency or immediately based on certain conditions being met.

Data that is to be collected by the smart sensors and pushed to the cloud to be analyzed includes, but may not be limited to: line queue volume, line dwell time, line queue volume stays above defined threshold for period of time, line queue volume stays below defined threshold for period of time, line dwell time exceeds defined threshold for period of time, average line queue volume over defined period of time, average dwell time over defined period of time, average length of time line queue volume stays above threshold, average length of time line queue volume stays below threshold, average length of time dwell time stays above threshold, average length of time dwell time stays below threshold, and danger/threat detection based on line queue motion data.

The relevant stakeholder groups that will receive notification alerts and/or data include, but may not be limited to store clerks, store managers, CPGs, consumers, and equipment OEMs. As a general rule, each notification trigger and data distribution set discussed in this disclosure can be mapped (one to one [1-1] and/or one to many [1-n]) to each of the delivery channels/mechanisms discussed.

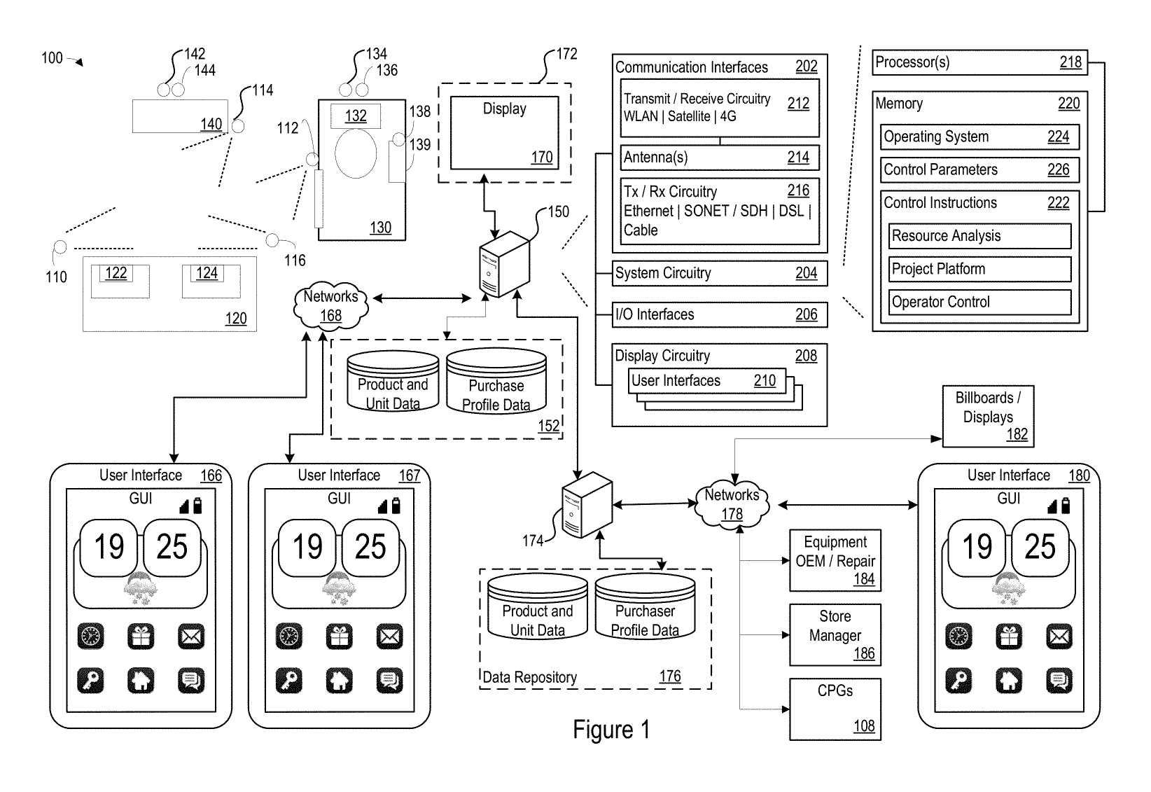

FIG. 1 is a block diagram of a queue monitoring system 100. The system 100 may include register line sensors 112, restroom line sensors 114, product line sensors 116, and other queue sensors at various points of interest in communication with a server 150. The system may include a number of sensors monitoring different queue characteristics at a retail location such as a convenience store. In one example, a restroom of a convenience store is monitored by the system 100. Although, the system may interact with multiple sensors at multiple convenience store locations simultaneously. The sensors may be smart sensors and therefore may receive and/or send data to a monitoring production server either directly or through a hub. A smart sensor may include a processor. The processor may allow the sensor to sample and transmit data upon receipt of a command to do so and/or continuously sample data to provide a continuous stream of data with regard to the characteristic being monitored, and/or monitor the data and evaluate if the data exceeds certain defined thresholds and send an alert in response to the monitored characteristic exceeding one or more thresholds. The alert may include and alert classification as well as the monitored data. The processor may also provide for the measurement unit to be calibrated and/or reset at the location of the sensor or remotely from a server. The sensor may include a display and/or end-user interface (e.g. buttons or switches, etc.) for setting and reviewing real time data as well as setting and monitoring alert information or threshold information. The sensors may comprise one or more cameras to view an area around the point of interest. The cameras may include CCD or CMOS sensors sensitive to the white light spectrum. The cameras may include infra-red and/or ultra violet sensors. The sensors may also use other sensing techniques including ultra-sonic, radar, and other technologies to sense persons in the queue. The sensors monitor characteristics related to queue characteristics, such as line volume (e.g. number of people in line), line dwell time (e.g. amount of time a person spends in line), line length (e.g. the distance the line extends), etc. Alerts may be generated in response to any of queue related characteristics noted herein, either based on a threshold or a comparison with other queue, product or unit characteristics.

Smart sensors, for example vision sensors with integrated processors, may be placed on the wall of the store outside bathrooms, around sales counters, around product display or dispensing stations. Sensors may collect data on the number of patrons entering and exiting the store and/or bathroom, and may also monitor when, how frequently, and for how long a person has remained in the queue or within the bathroom. Other use cases beyond this baseline are explored in the below document.

The sensor 110 may be positioned to monitor a field of view in front of a counter 120 where customers pay for gas or products. The counter 120 may include a first point of sale (POS) system 122. A first queue will generally form in front of the first POS system 122 by consumers waiting to pay for gas or products within the store. The sensor 110 may monitor characteristics of the first queue in front of the first POS system. This information may be linked to the number and types of items purchased by each consumer in the first queue. The counter may also include a second POS system 124. A second queue will generally form in front of the second POS system 124 by consumers waiting to pay for gas or products within the store. The sensor 110 may also monitor characteristics of the second queue in front of the second POS system. In such instances the field of view of sensor 110 may be widened to view in front of both POS systems at the same time or the sensor 110 may be linked to a motion mechanism to repetitively switch between a field of view in front of the first POS 122 and a field of view in front of the second POS 124. In some implementations, a sensor 116 may be mounted in a different location providing a field of view in front of the second POS system 124.

Sensor 112 may be positioned to monitor a field of view in front of a door to the restroom 130. A queue will generally form in front of the restroom door by people waiting to use the restroom 130. The restroom 130 may include a sink, a toilet 132, and a dispenser 139 (e.g. a hand towel, a toilet paper, a soap dispenser). Sensors may be located in the restroom 130 including, for example, a dispenser fullness or emptiness sensor 138, an overflow sensor 136, and a flush sensor 134. The sensor 112 may monitor characteristics of the queue (e.g. volume, dwell time, length) in front of the restroom 130. This information may be linked to a number of characteristics measured by other sensors in the restroom such as fullness/emptiness of dispensers, flood detection, toilet flushes. Further, the queue information and restroom information may be linked to the number and types of items purchased by each consumer over a corresponding timeframe.

Sensor 114 may be positioned to monitor a field of view in front of a product dispenser 140. A queue will generally form in front of the dispenser by people waiting to view or take products from the dispenser 140. The dispenser 140 may include a product fullness or emptiness sensor 142 and door open sensor 144. The sensor 114 may monitor characteristics of the queue (e.g. volume, dwell time, length) in front of the dispenser 140. This information may be linked to a number of characteristics measured by other sensors in the dispenser such as product fullness/emptiness sensor and door open sensor. Further, the queue information and dispenser information may be linked to the number and types of items purchased by each consumer over a corresponding timeframe.

Alerts may be generated based on measured queue characteristics. The store clerk may be notified to restock or perform maintenance tasks. This information may also be used to generate electronic coupons or in store advertisements in response to the measured characteristics. (e.g. if it is above or below a threshold offers such as discounts may be given) Data from these sensors may be communicated to a router or server 150 via a network 168 server 150. The network may be a wired network and/or a wireless network. As such, the sensors may include a wireless transmitter to connect to the server 150 via a wireless network such as Wi-Fi, BlueTooth, etc.

Upon receiving the data from the sensors the server 150 may store the data locally in a storage device 152. The server may also analyze the data and determine certain thresholds based on the characteristics of the sensor exceeding a certain value, or based on the comparison between various sensors, or based on an alert provided from a particular sensor the server 120 may communicate with a mobile device 166 that may be configured with an application for notifying a store clerk with an action needed to be taken with regard to maintenance or restocking. In addition, the server 150 may communicate with a mobile device 167 from a consumer based on an application loaded on the mobile device 167.

The application may allow the user to receive communication from a local network within the store 110. The application may allow the mobile device 167 to provide a user interface to present offers and/or electronic coupons to the consumer in response to the characteristics monitored by the smart sensors and/or a comparison of the smart sensors and/or a comparison of the monitored data with a threshold. In addition, the server 150 may be in communication with a display device 170 located within the store or on the store grounds as noted by box 172. The display 170 may be a public display, for example, a monitored unit or sign display to provide an offer or message to a consumer in response to queue information. The server 150 may communicate with an external server 174 located in a remote location such as corporate headquarters. The server 174 may receive data from the server 150. The server 150 may push the data to the server 174 and/or, the server 174 may request the data from the server 150. The data may be streamed in real time to the server 174 or accumulated and provided in batches, for example, after the store is closed or in the late evening hours. Further, certain data may be provided at different times based on a data priority. For example, alerts characteristic exceeded a certain threshold and generate a message that is immediately transmitted from server 150 to server 174 whereas the actual monitored data may be transmitted at a later time as a different priority. The data that the server 174 may be stored in a data storage unit 176 and may be retrieved by server 174 or other servers for additional data analysis. The server 174 may communicate via a network 178 with various other devices. For example, server 174 may communicate with a billboard display 182. The billboard display may display the characteristics that are monitored by the sensors located on the product preparation or dispensing devices. In addition, the billboard display may display ambient queue information from the store. The server 174 may communicate with an equipment OEM or repair facility 184. The server 174 may communicate with the equipment OEM or repair request system 184 to request maintenance. Further the system 174 may generate an offer such as an electronic coupon and send the electronic coupon to a user device 180 based on the queue information and additional information including for example the user profile information stored on the server 174 or the remote device 180, the location information related to the electronic device 184 other factors.

Store Clerk

The store clerk may receive notifications for various situations. The determination to transmit the notification may be in the server 150 located in the store 110 and/or by the remote server 174. The store clerk may receive notifications on a mobile or display device through a local network via server 150. The store clerk may receive notifications on various devices through a wide area network via server 150 or remote server 174. Notifications may be triggered in response to various events such as, line queue(s) volume exceeds defined threshold (open additional register), line queue(s) volume falls below defined threshold (close additional register), line dwell time exceeds defined threshold.

Individual notification triggers can be delivered via any or all of a POS system, Tablet App, Smartphone (App, SMS), Smartwatch (E-Mail), other wearable devices (E-mail, App, notification, SMS). General data may be distributed at the defined frequency, distributed based on a trigger or threshold being exceeded, and accessible any time in dashboard form via any or all of POS system, Tablet App, Smartphone (App, SMS link to Web landing).

Additional data sources that are potentially relevant for the store clerks may include Corporate systems (compliance info, updated process guidelines, other), CPG systems (offer availability), POS data (consumer purchasing history). Potentially amended process/use case for store clerks may include updated compliance information being sent from corporate systems to the store and, in combination with data sent from sensor device(s), the store clerk amends the queue thresholds or dashboard reporting frequencies (or other compliance related metrics) that have been previously set. Another process may include the clerk receiving alert when a purchaser particularly interested in queue characteristics (based on profile or preference history) enters the store. If a queue characteristic exceeds a certain threshold, he/she will be prompted to open offer dashboard provided by CPG system, check if an offer is available and, if so, volunteer to the consumer that the offer is available. In another implementation a work order may be issued in response to the purchaser entering the store.

Store Manager

The store manager may receive notifications for various situations. The determination to transmit the notification may be in the server 150 located in the store 110 and/or by the remote server 174. The store manager may receive notifications on a mobile or display device through a local network via server 150. The store manager may receive notifications on various devices through a wide area network via server 150 or remote server 174. Notifications may be triggered based on events such as, line queue volume stays above defined threshold for period of time, line queue volume stays below defined thresholder for period of time, line dwell time exceeds defined threshold for period of time.

Additional collected data from the sensors may be delivered at defined time/time interval(s) and analyzed for sending additional notifications based on a exceeding a threshold (upper, lower, or based on a comparison) of one or more of average line queue volume over defined period of time, average dwell time over defined period of time, average length of time line queue volume stays above threshold, average length of time line queue volume stays below threshold, average length of time dwell time stays above threshold, average length of time dwell time stays below threshold, and danger/threat detection based on line queue motion data.

Individual notification triggers can be delivered via any or all of POS system, Tablet App, Smartphone (App, SMS), Smartwatch (App, SMS), Other wearable devices (E-mail, App, notification, SMS), Desktop PC (E-Mail, Web Landing Page), Laptop PC (E-Mail, Web Landing Page). General data may be distributed at the defined frequency, distributed based on a trigger or threshold being exceeded, and accessible any time in dashboard form via any or all of POS system, Tablet App, Smartphone (App, SMS link to Web landing), Smartwatch (App, SMS link to Web landing), Other wearable devices (E-mail, App, notification, SMS), Desktop PC (E-Mail, Web Landing Page), Laptop PC (E-Mail, Web Landing Page).

Additional data sources that are potentially relevant for the store managers may include Corporate systems (compliance info, updated process guidelines, other), CPG systems (offer availability), Store systems (clerk performance history), POS system (consumer purchasing history). Potentially amended process/use case for store managers may include updated compliance information being sent from corporate systems to the store and, in combination with data sent from sensor device(s), the store clerk amends the queue parameters (e.g. queue thresholds) that have been set. Another process may include generating information accessible in dashboard form for manager to pull down. Another process may include generating dashboard reports for sensor device, pushed to the manager at a defined frequency, that provide info, graphics, and/or alerts around sensor management and compliance can be a key data point that is used in combination with other clerk performance data to enhance the performance appraisal process.

CPGs

The CPGs or food service vendors may receive notifications for various situations. The determination to transmit the notification may be in the server 150 located in the store 110 and/or by the remote server 174. The CPGs or food service vendors may receive notifications on a mobile or display device through a local network via server 150. The CPGs or food service vendors may receive notifications on various devices through a wide area network via server 150 or remote server 174. Notifications may be triggered based on events such as, average dwell time exceeds or falls below threshold (suggest to give offer) and average volume exceeds or falls below threshold (suggest to give offer).

Additional collected data from the sensors may be delivered at defined time/time interval(s) and analyzed for sending additional notifications based on a exceeding a threshold (upper, lower, or based on a comparison) of one or more of average line queue volume over defined period of time, average dwell time over defined period of time, average length of time line queue volume stays above threshold, average length of time line queue volume stays below threshold, average length of time dwell time stays above threshold, average length of time dwell time stays below threshold.

Individual notification triggers can be delivered via any or all of POS system, Tablet App, Smartphone (App, SMS), Smartwatch (App, SMS), Other wearable devices (E-mail, App, notification, SMS), Desktop PC (E-Mail, Web Landing Page), Laptop PC (E-Mail, Web Landing Page). General data may be distributed at the defined frequency, distributed based on a trigger or threshold being exceeded, and accessible any time in dashboard form via any or all of POS system, Tablet App, Smartphone (App, SMS link to Web landing), Smartwatch (App, SMS link to Web landing), Other wearable devices (E-mail, App, notification, SMS), Desktop PC (E-Mail, Web Landing Page), Laptop PC (E-Mail, Web Landing Page).

Additional data sources that are potentially relevant for the CPGs may include a POS system (consumer purchasing history). Potentially amended process/use cases for CPGs may include analyzing the propensity for loyal consumers to purchase or enter store, as a function of queue, are made available to the CPG (hence answering the question—how effective are queue driven product offers or messages).

Consumers

The consumers may receive notifications for various situations. The determination to transmit the notification may be in the server 150 located in the store 110 and/or by the remote server 174. The consumers may receive notifications on a mobile or display device through a local network via server 150. The consumers may receive notifications on various devices through a wide area network via server 150 or remote server 174. Notifications may be triggered based on events such as, CPG offer is available based on line queue dwell time and CPG offer is available based on line queue volume.

Additional collected data from the sensors may be delivered at defined time/time interval(s) and analyzed for sending additional notifications based on a exceeding a threshold (upper, lower, or based on a comparison) of one or more of a average line queue volume over defined period of time, average dwell time over defined period of time, average length of time line queue volume stays above threshold, average length of time line queue volume stays below threshold, average length of time dwell time stays above threshold, average length of time dwell time stays below threshold, and danger/threat detection based on line queue motion data.

Individual notification triggers can be delivered via any or all of an Electronic LED, Tablet App, Smartphone (App, SMS), Smartwatch (App, SMS), Other wearable devices (E-mail, App, notification, SMS), Smart car infotainment (App, Alert). General data may be distributed at the defined frequency and accessible any time via any or all of an Electronic LED, Tablet App, Smartphone (App, SMS link to Web landing), Smartwatch (App, SMS link to Web landing), Desktop PC (E-Mail, Web Landing Page), Laptop PC (E-Mail, Web Landing Page)

The server 150 and/or server 174 includes communication interfaces 202, system circuitry 204, input/output (I/O) interfaces 206, and display circuitry 208 that generates user interfaces 210 locally or for remote display, e.g., in a web browser running on a local or remote machine through which a project is defined and resources are selected, evaluated, allocated, and connected to a project. The user interfaces 210 and the I/O interfaces 206 may include graphical user interfaces (GUIs), touch sensitive displays, voice or facial recognition inputs, buttons, switches, speakers and other user interface elements. Additional examples of the I/O interfaces 206 include microphones, video and still image cameras, headset and microphone input/output jacks, Universal Serial Bus (USB) connectors, memory card slots, and other types of inputs. The I/O interfaces 206 may further include magnetic or optical media interfaces (e.g., a CDROM or DVD drive), serial and parallel bus interfaces, and keyboard and mouse interfaces.

The communication interfaces 202 may include wireless transmitters and receivers (“transceivers”) 212 and any antennas 214 used by the transmit and receive circuitry of the transceivers 212. The transceivers 212 and antennas 214 may support WiFi network communications, for instance, under any version of IEEE 802.11, e.g., 802.11n or 802.11ac. The communication interfaces 202 may also include wireline transceivers 216. The wireline transceivers 216 may provide physical layer interfaces for any of a wide range of communication protocols, such as any type of Ethernet, data over cable service interface specification (DOCSIS), digital subscriber line (DSL), Synchronous Optical Network (SONET), or other protocol.

The system circuitry 204 may include any combination of hardware, software, firmware, or other circuitry. The system circuitry 204 may be implemented, for example, with one or more systems on a chip (SoC), application specific integrated circuits (ASIC), microprocessors, discrete analog and digital circuits, and other circuitry. The system circuitry 204 is part of the implementation of any desired functionality in the server 150 and/or server 174. As just one example, the system circuitry 204 may include one or more instruction processors 218 and memories 220. The memory 220 stores, for example, control instructions 222 and an operating system 224. In one implementation, the processor 218 executes the control instructions 222 and the operating system 224 to carry out any desired functionality for the server 150 and/or server 174. The control parameters 226 provide and specify configuration and operating options for the control instructions 222, operating system 224, and other functionality of the server 150 and/or server 174.

The server 150 and/or server 174 may include a local data repository 232 that includes volume storage devices, e.g., hard disk drives (HDDs) and solid state disk drives (SDDs). The storage devices may define and store databases that the control instructions 222 access, e.g., through a database control system, to perform the functionality implemented in the control instructions 222. In the example shown, the databases include a resource data database 228 and a project data database 230. In other implementations, any of the databases may be part of a single database structure, and, more generally, may be implemented logically or physically in many different ways. Each of the databases defines tables storing records that the control instructions 222 read, write, delete, and modify to perform the processing noted below. The resources descriptors may maintain their own resource descriptor data repositories. The system circuitry 204 may implement the resource analysis circuitry, project platform circuitry, and the operator control circuitry, e.g., as control instructions 222 executed by the processor 218.

The thresholds and alerts may be stored in one or more data bases and may be associated with the sensor or device. For example, separate thresholds for each queue characteristic may be stored for each sensor in a sensor record. Separate thresholds for characteristic of a device may be stored for each device in a device record.

Similar offers such as electronic coupons, in store advertisements or POS offers may be stored in records related to the sensor, or device, or a purchaser profile. Further, the offers may be generated and/or delivered in response to characteristics from or combinations of characteristics from the sensor characteristic, device characteristic, and a purchaser profile. Redemptions of electronic coupons and or purchases corresponding with in store advertisements may be tracked and analyzed with respect to the characteristics (e.g. line queue volume, dwell time, etc.) that were used to generate and/or deliver the offer. As such, the usefulness of the offers may be maximized. This may even be controlled in a feedback loop where the thresholds are adjusted based on redemption data and/or purchase correlation data.

The methods, devices, processors, modules, engines, and logic described above may be implemented in many different ways and in many different combinations of hardware and software. For example, all or parts of the implementations may be circuitry that includes an instruction processor, such as a Central Processing Unit (CPU), microcontroller, or a microprocessor; an Application Specific Integrated Circuit (ASIC), Programmable Logic Device (PLD), or Field Programmable Gate Array (FPGA); or circuitry that includes discrete logic or other circuit components, including analog circuit components, digital circuit components or both; or any combination thereof. The circuitry may include discrete interconnected hardware components and/or may be combined on a single integrated circuit die, distributed among multiple integrated circuit dies, or implemented in a Multiple Chip Module (MCM) of multiple integrated circuit dies in a common package, as examples.

The circuitry may further include or access instructions for execution by the circuitry. The instructions may be stored in a tangible storage medium that is other than a transitory signal, such as a flash memory, a Random Access Memory (RAM), a Read Only Memory (ROM), an Erasable Programmable Read Only Memory (EPROM); or on a magnetic or optical disc, such as a Compact Disc Read Only Memory (CDROM), Hard Disk Drive (HDD), or other magnetic or optical disk; or in or on another machine-readable medium. A product, such as a computer program product, may include a storage medium and instructions stored in or on the medium, and the instructions when executed by the circuitry in a device may cause the device to implement any of the processing described above or illustrated in the drawings.

The implementations may be distributed as circuitry among multiple system components, such as among multiple processors and memories, optionally including multiple distributed processing systems. Parameters, databases, and other data structures may be separately stored and managed, may be incorporated into a single memory or database, may be logically and physically organized in many different ways, and may be implemented in many different ways, including as data structures such as linked lists, hash tables, arrays, records, objects, or implicit storage mechanisms. Programs may be parts (e.g., subroutines) of a single program, separate programs, distributed across several memories and processors, or implemented in many different ways, such as in a library, such as a shared library (e.g., a Dynamic Link Library (DLL)). The DLL, for example, may store instructions that perform any of the processing described above or illustrated in the drawings, when executed by the circuitry.

As a person skilled in the art will readily appreciate, the above description is meant as an illustration of implementation of the principles this disclosure. This description is not intended to limit the scope or application of this system in that the system is susceptible to modification, variation and change, without departing from the spirit of this disclosure, as defined in the following claims.

I/we claim:

1. A system for monitoring a queue comprising:
a sensor configured to measure a queue characteristic and generate a queue measurement signal;
a processor configured to receive the queue measurement signal;
a transmitter configured to receive queue information from the processor and transmit a message based on the queue information.

2. The system according to claim 1, wherein the sensor comprises a camera positioned to view the queue.

3. The system according to claim 1, wherein the sensor measures a volume of the queue.

4. The system according to claim 1, wherein the sensor measures a dwell time of a person in the queue.

5. The system according to claim 1, wherein the sensor measures a length of the queue.

6. The system according to claim 1, wherein the processor is configured to compare the volume of the queue to a queue volume threshold such that the transmitter transmits the message based on queue volume and the queue volume threshold.

7. A system for monitoring queue of a retail store, the system comprising:
a server;
a database in communication with the server and storing queue parameters;
at least one sensor configured to transmit measured queue characteristics to the server, wherein the server is configured to generate and transmit a message based on a comparison of the measured queue characteristics and the queue parameters stored in the database.

8. The system according to claim 7, wherein the message is transmitted to a consumer in response to a profile associated with the consumer including a queue importance setting.

9. The system according to claim 7, wherein the message is transmitted by the server to a store clerk, a store manager, or an consumer.

10. The system according to claim 7, wherein the message is transmitted to a consumer in response to a line queue volume exceeding a defined threshold for period of time.

11. The system according to claim 7, wherein the message is transmitted to a consumer in response to a line dwell time exceeding a defined threshold for period of time.

12. The system according to claim 7, wherein the message is transmitted to a consumer in response to an average line queue volume over defined period of time.

13. The system according to claim 7, wherein the message is transmitted to a consumer in response to an average dwell time over defined period of time.

14. The system according to claim 7, wherein the message is transmitted to a consumer in response to an average length of time line queue volume stays above a threshold.

15. The system according to claim 7, wherein the message is transmitted to a consumer in response to an average length of time line queue volume stays below a threshold.

16. The system according to claim 7, wherein the message is transmitted to a consumer in response to an average length of time that dwell time stays above threshold.

17. The system according to claim 7, wherein the message is transmitted to a consumer in response to an average length of time that dwell time stays below threshold.

18. The system according to claim 7, wherein the message is transmitted to a consumer in response to threat detection based on line queue motion data.

19. A system for monitoring a queue of a retail store, the system comprising:
a server;
a database in communication with the server and storing queue parameters;
at least one sensor configured to transmit queue characteristics to the server, wherein the server is configured to generate and transmit a message based on a comparison of the measured queue characteristics and the queue parameters stored in the database.

20. The system according to claim 19, further comprising at least one sensor configured to measure a queue volume and dwell time and the message is transmitted based on the queue volume and dwell time.
